(19) United States
(12) Patent Application Publication
(10) Pub. No.: US 2015/0260509 A1
(43) Pub. Date: Sep. 17, 2015

(54) THREE DIMENSIONAL (3D) IMAGING BY A MOBILE COMMUNICATION DEVICE

(71) Applicants: Jonathan KOFMAN, Waterloo (CA); Dong LI, Guelph (CA)

(72) Inventors: Jonathan KOFMAN, Waterloo (CA); Dong LI, Guelph (CA)

(21) Appl. No.: 14/204,582

(22) Filed: Mar. 11, 2014

(51) Int. Cl. G01B 11/25

(52) U.S. Cl. CPC G01B 11/2504; G01B 11/2513

(57) ABSTRACT

The disclosure is directed at a method for three-dimensional (3D) imaging for use by a handheld portable device including projecting at least one fringe pattern onto a surface; capturing a two-dimensional (2D) camera image of each deformed light pattern formed by the projected at least one fringe pattern; and determining shape of the surface and an apparatus for performing such method.

### FIELD OF THE DISCLOSURE

The present disclosure is generally directed at three-dimensional (3D) imaging and more specifically, the disclosure is directed at 3D imaging by a mobile communication device.

### BACKGROUND OF THE DISCLOSURE

Over the last few years, the use of mobile communication devices has grown. What was originally considered for use as a cellular telephone has evolved to these devices being seen as smartphones. As mobile communication device use grows, there has been an increase in the functionality of these devices. New applications are regularly being created which allow the mobile communication device to be used as a flashlight, a camera, a music player as well as a web browser.

One area which has not been widely explored for mobile communication devices is in the field of imaging or scanning. While three-dimensional (3D) imaging is well-known, there are some problems with implementing such functionality in mobile communication devices.

One of the problems with implementing existing 3D scanning methods on a mobile communication device, or “smartphone” as they are sometimes referred to, is related to the complexity of satisfying multiple needs simultaneously with a single apparatus and method. These include satisfying the need for the fast capture of images; satisfying the need for accurate high resolution 3D images and complexity of the scanning method in order to yield accurate high resolution 3D images; satisfying the need for the user to use the mobile communication device for other applications (such as phone calls, texting, web browsing, playing games, executing other applications and two-dimensional (2D) image capture) when they are not performing 3D imaging; and satisfying the need for extremely simple setup before the user can perform 3D imaging.

The complexity of satisfying these multiple needs simultaneously is believed to be one of the reasons why 3D imaging using a mobile communication device is not widely available.

Therefore, there is provided a novel method and apparatus for 3D imaging by a mobile communication device which overcomes some of the disadvantages of current systems.

### SUMMARY OF THE DISCLOSURE

The disclosure is directed at a method and apparatus of three-dimensional (3D) imaging for use with a mobile communication device. The method and apparatus of the current disclosure is preferably directed at use for the acquisition of accurate high resolution 3D images of surfaces of objects using mobile communication devices (MCDs) such as, but not limited to, i-Phone™, Nexus™, Galaxy™, Blackberry™ and i-Pod Touch™, all of which are small hand-held devices that include 2D imaging, 3G or WiFi communication, and computing capability. In an alternative embodiment, the method and apparatus of the disclosure may be applicable to, larger devices such as, but not limited to, a computer tablet (i-Pad™) or laptop computer, which have the same capabilities. The disclosure is also applicable to devices which do not have computing capability such as a digital camera, some of which include WiFi communication, where the computing may be performed by a remote computer. The disclosure may permit a user to measure the 3D geometry of a surface, or in more common language, capture a 3D image of an object surface or measure the 3D shape of the object surface, using the MCD. In other words, 3D coordinates of the object surface may be obtained by this 3D surface-shape measurement.

For ease of understanding, in the remainder of this disclosure, when the term MCD is used, it is meant to also include devices that do not have cellular communication capability, such as an i-Pod Touch™.

This disclosure allows a common consumer to be able to use a smartphone or other MCD that they already have in their possession to acquire a 3D image of an object surface rather than purchase a bulky and expensive scanning system.

While various techniques of measuring 3D surfaces exist, these techniques have been developed for industrial applications with high quality cameras and projectors, and all device control and computing have been performed on a computer. The disclosure is for 3D surface measurement (3D image acquisition) aimed at common consumers that enables accurate high resolution 3D imaging to be carried out by a MCD.

This disclosure addresses this need of the consumer—an apparatus and method to enable accurate high resolution 3D imaging by a common smartphone or other MCD (to measure the 3D surface of objects such as faces, household objects, sculptures).

The disclosure utilizes novel approaches that would not be obvious to someone in any of the imaging fields to enable the invention to satisfy the multiple needs and the objective of accurate high resolution 3D imaging by a smartphone or other MCD.

Among various 3D scanning methods, methods that project a single line of structured light require time-consuming scanning of the light line across an object, a physical means to scan the light across the surface, and a means to integrate all the acquired profile data into a single surface model. Projection of multiple lines of light aids to acquire more 3D surface information simultaneously from a single viewpoint but results in ambiguity of the line number on complex surfaces, and may still leave spaces between acquired surface profiles. A full-field scanning approach, where a full-field light pattern is projected onto an object and a 3D coordinate can be calculated at every image pixel, would be more suitable for the common consumer, who would want to acquire a surface shape of an object in an instant (less than a few seconds). A two-camera stereo camera system could also capture full-field images, however, the cameras capture 2D images and there is considerable complexity and unreliability (inaccuracy) in determining correspondences between the two camera images for all image points in order to reconstruct 3D full-field images.

### BRIEF DESCRIPTION OF THE DRAWINGS

Embodiments of the present disclosure will now be described, by way of example only, with reference to the attached Figures.

FIG. 1 is a schematic diagram of camera-projector stereovision system;

FIG. 2 is a schematic diagram of the generation of orthogonal absolute phase maps;

FIG. 3A is a schematic diagram of a camera-captured checkerboard image with calibration point;

FIG. 3B is a schematic diagram of an intersection of two absolute phase lines;

FIG. 4 is a schematic diagram of apparatus for 3D imaging;

FIG. 5 is a schematic diagram of a first embodiment of using alignment rectangles in the MCD camera viewer to align a recalibration device; and

FIG. 6 is a schematic diagram of another embodiment of using alignment rectangles in the MCD camera viewer to align a recalibration device.

### DETAILED DESCRIPTION OF THE DISCLOSURE

Full-field 3D imaging systems typically project fringe patterns onto an object surface and images of the deformed patterns that appear on the object surface are captured by one or more cameras positioned at an angle to the projector. What is common to all systems is that the camera-projector system must be calibrated and the calibration is specific to the geometry of the camera-projector setup. In laboratory or industrial settings, where the environment is highly controlled, a rigorous calibration of the 3D imaging system involving many steps are typically performed by a technically knowledgeable user. For a consumer device, the 3D imaging system can be factory calibrated by the manufacturer without requiring further calibration by the user, assuming that the 3D imaging system is constructed with a projector and camera(s) mounted permanently in a frame so that the camera(s) and projector have no relative movement between them once the system is factory calibrated. However, neither of these approaches are suitable to enable 3D imaging by a consumer or user using a smartphone or MCD. The user would like to use their smartphone for numerous varied tasks such as phone calls, texting, surfing the internet, playing games, running applications (apps) for numerous other purposes, and 2D image capture—i.e. taking photos, when they are not performing 3D imaging. The user would therefore need to have their smartphone physically disconnected from other devices, such as the projector, to allow these tasks to be done comfortably without physical hindrance. For 3D imaging, the user would have to re-connect the smartphone/MCD to the projector and possibly perform some recalibration before performing any 3D imaging.

System calibration by the manufacturer without requiring further calibration by the user would hardly be possible, since the user's use of the MCD with the MCD disconnected from the projector would require system recalibration. This is because once the MCD (MCD's camera) is physically disconnected from the projector, there could be no guarantee upon reconnecting the MCD (camera) to the projector for 3D imaging purposes that the geometry of the MCD-projector setup would be identical with high precision to the geometry of the MCD-projector setup during the calibration by the manufacturer. Rigorous system calibration involving many steps is not suitable for a common user using their smartphone or MCD, since they would expect more ready use of the disclosed 3D imaging feature of a smartphone or MCD.

The disclosure enables a common consumer user, to use their smartphone or MCD as desired for various activities, and then using a rigid docking device to physically connect their MCD device to a projector that projects fringe patterns when they are ready to use the device for 3D imaging, and perform a simple single-step or two-step operation, that will allow the system to recalibrate itself without having to follow the common multiple step calibration procedure normally used for accurate 3D surface-shape measurement (3D imaging). It is this novel approach which allows consumer use of a smartphone/MCD to be used with techniques for fringe projection to provide a 3D imaging system for a mobile communication device.

The disclosure is directed at a method and apparatus of 3D imaging for use with a mobile communication device (MCD). In one embodiment, the disclosure includes a MCD executing a recalibration procedure. Furthermore, unless clearly specified, the term “camera” refers to the camera of the MCD.

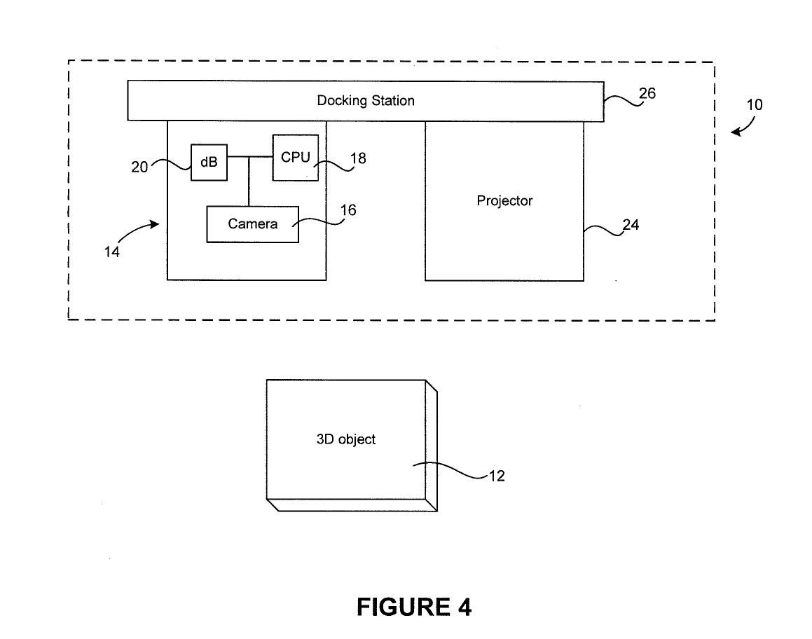

Turning to FIG. 4, an embodiment of apparatus for 3D imaging is shown. The apparatus 10 is for use in capturing a 3D image of a 3D object 12. The apparatus includes a MCD 14 which includes a camera 16, a processor 18 and a database 20. The apparatus 10 may also include a connecting apparatus, such as a docking station 26, which is used to connect a projector 24 (or light pattern generator) to the MCD 14. In some embodiments, the docking station 26 is a mounting bracket to rigidly fix the MCD 14 to the projector 24, and in other embodiments the docking station 26 is a mounting bracket as well as a physical communication means that includes electronic ports between the projector 24 and MCD 14. The use of projector 24 with the MCD 14 will be described in more detail below.

In one embodiment, the projector 24 is a miniature or pico projector along with standard accessories such as, but not limited to, a remote control handset. However, any device that can project fringe patterns may be used as a projector.

The docking station 26 allows the user to repeatedly connect and disconnect the MCD 14 to and from the projector 24. The docking station also allows the positional and angular relationship between the MCD 14 and the projector 24 to be fixed temporarily. In one embodiment, the docking station also allows the positional and angular relationship between the MCD 14 and the projector 24 to be adjusted, if necessary. In one embodiment, the docking station 26 provides apparatus to rigidly fix the MCD 14 to the projector 24 such that their optical axes approximately intersect on the surface of the object 12. In another embodiment, the docking station 26 and a mounting apparatus may be separate parts.

In one embodiment, the method and apparatus provides repeatable relative positioning between the MCD 14 and projector 24 via the docking station 26 with sufficiently high precision such that calibration of the MCD and projector does not need to be done by the end-user; instead the MCD/projector calibration may be done by the manufacturer of the MCD 14, docking device 26, or projector 24; and the 3D surface-shape measurement can then be carried out by the end user without system calibration.

In one embodiment of operation, the MCD 14 and the projector 24 may be recalibrated with the assistance of a recalibration object which may be the 3D object 12. In another embodiment, the recalibration object is different from the 3D object 12.

In the preferred embodiment, stored within the processor 18 or the database 20, are individual procedures which assist in a method of 3D image capture. These procedures include, but are not limited to, a recalibration procedure to recalibrate the MCD 14 with the projector 24 involving acquisition of images of the recalibration object; and computation of new calibration parameters based on the calibration parameters from a previous calibration to recalibrate the MCD 14 and the projector 24; and a fringe-projection full-field 3D imaging technique.

The fringe-projection full-field 3D imaging technique includes but is not limited to, projection of one or more fringe patterns, image capture of each fringe pattern, reconstruction of the 3D object surface (from image(s) of the fringe pattern (s)).

There is additional apparatus to enable recalibration of the MCD-projector or camera-projector system by the end-user for embodiments where end-user recalibration is enabled or possible. The recalibration apparatus is described in more detail below.

Various embodiments of the docking station 26 to connect the MCD to the projector by rigidly fixing the MCD to the projector are contemplated. In one such embodiment (in a simplest form), the connecting apparatus (docking station 26) is a plate with a first hole to allow the mounting of the projector 24 to the plate by a fastener such as a screw through the first hole, and a second hole to allow the mounting of the MCD 14 to the plate by a fastener such as a screw through the second hole. If the MCD does not have a threaded mounting hole, then a mounting block that holds the MCD may be used, and the mounting block would have a threaded hole that would be used to mount the block to the plate.

In an alternative mounting of the MCD to the plate (docking station 26), the plate includes a slot which allows insertion of the MCD into the slot, and a set screw to hold the MCD firmly in the slot in the proper orientation while the projector 24 is mounted as disclosed above.

In a further embodiment, the plate has a tapered slot in the plate to allow insertion of the MCD into a tapered slot such that the MCD can be repeatedly placed and removed from the slot by the user, and always be placed in the same position and orientation with high precision (high repeatability) while the projector is mounted in a manner as disclosed above. In yet another embodiment, the mounting apparatus includes a bracket in the form of a rectangular ring that is fixed semi-permanently to the MCD 12 by force fit, or by set screws, or other means, and the bracket contains a block (either square or dovetail shaped so that it will precisely fit into the square or dovetails hole in the plate with a fixed bottom) such that the MCD can be repeatedly placed and removed from the slot by the user, and always be placed in the same position and orientation with high precision (high repeatability).

In yet a further embodiment, the projector is permanently attached to the plate, connecting apparatus, mounting bracket, or docking station 26.

Another embodiment has the projector permanently built into the MCD, such as by the manufacturer of the MCD.

In a further embodiment, the projector is permanently built into the MCD by the manufacturer of the MCD, and a reorienting of the projector or camera optical axes by means of various optical components such as but not limited to mirrors and lens is preferred or re-orienting the projector such as by rotating on a hinge or pivot such as with flip-type mobile communication devices.

In each of the embodiments, depending on the particular MCD, the height of the MCD and projector can be adjusted so that the optical axes of the camera and projector are approximately at the same height, using an appropriate sized block, or selectable positions on a vertical plate, or adjustable positions on a plate with a slot, or similar method. Similarly, in all of the above, the tilt of the optical axes can be made adjustable by a pivoting plate or wedge, to adjust the optical axes of the camera and projector up and down.

In one arrangement of the camera and projector, the camera and projector are approximately in the same horizontal plane. In an alternative arrangement of the camera and projector, the projector is placed above the camera, or the camera above the projector, and the angle between the camera and projector optical axes is in a near vertical plane rather than a near horizontal plane.

In an improvement over other known methods, the recalibration procedure uses the calibration parameters from the previous calibration or recalibration (of the camera within the MCD 14 and projector 24), such as the most recent recalibration or calibration, or the calibration by the original manufacturer as a starting calibration, and then optimally adjusts the calibration parameters, to account for the new physical pose (position and orientation) of the MCD 14 relative to the projector 24.

In this embodiment, the recalibration procedure using the last used calibration parameters would tend to “keep track” of the user's tendencies in docking the MCD 14 with the projector 24. The docking station 26 would achieve a certain repeatability in position and orientation of the MCD 14 in remounting the MCD 14 with the projector 24.

The recalibration procedure would preferably correct for any non-repeatability or imperfect mounting of the MCD 14 with the docking station 26.

Without this novel aspect of the disclosure, others skilled in the art of 3D imaging would not consider fringe projection 3D imaging as viable for use with the MCD 14 since common consumers would not want to perform a multiple step complex calibration every time they want to acquire a 3D image of an object (which is typically what is required for a fringe projection technique) and it would be difficult for manufacturers to manufacture a high precision docking station 26 for the MCD 14 to the projector 24 that would enable highly repeatable positioning of the MCD 14 relative to the projector 24, without requiring recalibration, when the positioning is carried out by an individual. It is believed that those skilled in 3D imaging have not considered the unique combination of apparatus and methods of this disclosure to enable accurate high resolution 3D imaging by a MCD 14.

In another embodiment, the method and apparatus enables full calibration of the MCD/projector by the end-user in addition to the 3D surface-shape measurement by the end user.

Accurate High Resolution 3D Imaging

In one aspect, in order to achieve more accurate high resolution 3D imaging over known methods, fringe projection is used as it is one of few techniques that permits 3D full-field imaging. For the current disclosure, a couple of methods of fringe projection are preferred, however, others may be contemplated. Colour, gray, or binary (black and white) encoded fringe patterns are alternative methods among those contemplated.

For the current disclosure, the two methods are a) Sinusoidal-intensity fringe-pattern projection, typically using three or four phase-shifted patterns and b) Triangular-intensity pattern two-step phase shifting, which uses intensity ratios rather than phase. The two-step triangular intensity pattern enables faster imaging by using projection of two images rather than three or four, and using intensity-ratio equations to compute an intensity ratio rather than the more computationally expensive arctangent function to compute phase, as disclosed in U.S. Pat. No. 7,545,516 entitled Full-Field Three-Dimensional Measurement Method which issued on Jun. 9, 2009 and is hereby incorporated by reference.

Both the sinusoidal and triangular pattern fringe projection techniques involve considerable complexity involving different multi-step calibration procedures. The complexity of the techniques is required to provide the accurate high resolution imaging. It is the complexity of the calibration required for the sinusoidal and triangular pattern fringe projection techniques which has dissuaded attempts to use a MCD as a 3D imaging apparatus in the past.

Setup for 3D Imaging—Single Step or Two-Step Recalibration

In operation, two recalibration procedures are contemplated. The first embodiment may be referred to as a MCD/projector stereovision calibration while the second embodiment may be referred to as phase-to-height mapping calibration. The apparatus and method for each of the recalibration procedures are applicable to variations in the fringe projection 3D imaging and calibration methods (not only to the methods described below). For each of the two methods, the calibration and 3D measurement methods are described first as background information, followed by the recalibration method.

Camera-Projector Stereovision Calibration

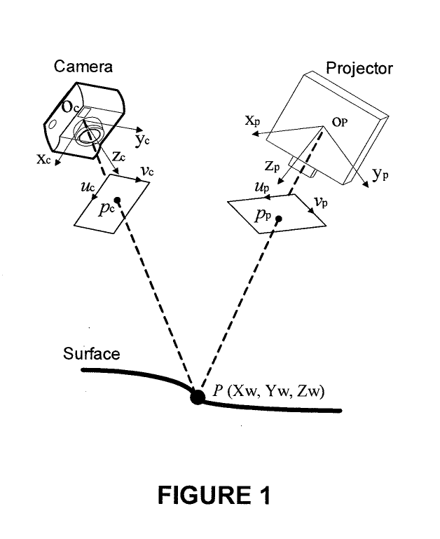

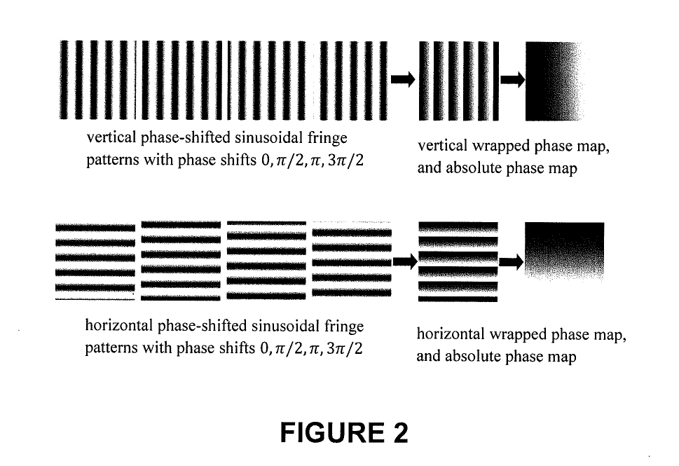

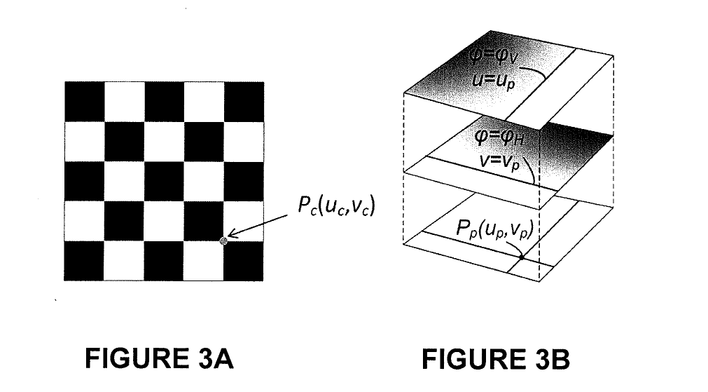

In this first embodiment of recalibration, the camera within the MCD (further referred to as “camera”) and projector can be considered as a stereo system with the projector treated as an inverse camera such as shown in FIG. 1. Virtual projector images and real camera-captured images of a planar calibration board or calibration object in multiple poses (positions and orientations) are required. The calibration board preferably contains multiple calibration points at known relative positions in the plane. (For instance, the calibration board may be a checkerboard, where the corners of the squares are the calibration points; or with an array of white circles on a black background, where the centres of the circles are the calibration points; or other patterns of points). To determine the corresponding pixels between camera and projector images, horizontal fringe patterns and vertical fringe patterns (FIG. 2) are projected onto the calibration board (FIG. 3a) and the phase is calculated at the calibration points seen in the camera images, for both the horizontal and vertical sets of fringe patterns, respectively. (Equations 1 and 2 below). The horizontal and vertical phase values at the known calibration points seen in the camera images (FIG. 3b) are used to determine the correspondences between the projector pixels (rays) and camera pixels, and thus create the virtual projector image of calibration points. The projector and camera can then be calibrated using techniques for a two-camera stereo vision system, where the calibration board is positioned in multiple (6-15 or other number) poses (position and orientation) that occupy the calibration volume, and a camera image and projector virtual image of the calibration board are acquired for each pose. The relative pose between the camera and projector coordinate systems can then be determined from the locations of the calibration points in the images (camera image and projector virtual image) and the known relative spacing of the points within the plane. For the projector, virtual images, explained above, are used. Calibration parameters for the camera, projector, and the relative pose between them are thus obtained. Measurement of the 3D surface geometry of an object can then be carried out by projecting horizontal and vertical fringe patterns onto the surface of interest, determining the phase values in the camera images and finding the corresponding phase values in the projector images, determining the corresponding pixels in the camera and projector images, and using the system calibration parameters to reconstruct the 3D coordinates of the surface point for each camera pixel.

Absolute Phase-Map Generation

In fringe-projection phase-shifting for surface-shape measurement, a phase map is generated by projecting a set of phase-shifted sinusoidal intensity-profile fringe patterns onto an object surface, and capturing images of the patterns with intensity distributions described by:

I(x,y)=a(x,y)+b(x,y)cos [Φ(x,y)+δᵢ],i=1,2, . . . , N (1)

where (x, y) are the image coordinates, a(x, y) denotes the background intensity, b(x, y) represents the intensity modulation, Φ(x, y) is the phase map, δᵢ=2πi/N are the phase-shifts between images, and N is the number of phase-shifted fringe patterns. At least three phase-shifted fringe patterns are required to solve for the three unknowns a(x, y), b(x, y) and Φ(x, y). The phase map can then be computed by

$$Φ ( x , y ) = - {tan}^{- 1} ( \frac{{\sum }_{i = 1}^{N} {I}_{i} ( x , y ) sin {δ}_{i}}{{\sum }_{i = 1}^{N} {I}_{i} ( x , y ) cos {δ}_{i}} ) , i = 1 , 2 , … , N . \qquad ( 2 )$$

Due to the inverse tangent operator, Eq. (2) calculates a wrapped phase map Φ(x, y). Phase unwrapping is carried out by adding multiples of 2π to the wrapped phase map Φ(x, y) according to fringe order, to remove the 2π periodicity and thus eliminate fringe ambiguity in the wrapped phase map, resulting in an absolute phase map φ(x, y).

Camera-Projector Correspondence from Absolute Phase Maps

Correspondence between camera and projector pixels is determined using two orthogonal absolute phase maps. Using a planar calibration object, for example, in the form of a checkerboard, where the inner corners of squares define the control (calibration) points, or in the form of an array of white circles on a black background, where the centroids of the circles define the control (calibration) points, for each control point P_{c}(u_{c}, v_{c}) of the calibration object in the calibration-object camera image (FIG. 3a), the correspondence between the camera pixel and projector pixel is determined by matching the absolute phase value pair (φ_{V},φ_{H}) (computed from vertical and horizontal phase-shifted sinusoidal fringe patterns, respectively, (FIG. 2), in the camera and projector images, respectively. Matched point Pₚ(uₚ, vₚ) in the projector image (FIG. 3b), which occurs at the intersection of a vertical line u=uₚ with absolute phase value φ=φ_{V} and a horizontal line v=vₚ with absolute phase value φ=φ_{H} corresponds to control point P_{c}(u_{c}, v_{c}) in the camera image plane (FIG. 3a). Construction of a virtual projector image of the checkerboard is complete once all the control points have been matched, and this completes the determination of correspondence between camera and projector pixels.

An alternative to projection of horizontal and vertical fringe patterns is projection of only horizontal or only vertical fringe patterns and known epipolar geometry techniques are used to complete the determination of correspondence between projector and camera coordinates, from the horizontal-pattern derived or vertical-pattern derived absolute phase map.

Camera-Projector Correspondence

Mapping of the camera and projector image coordinates to the world coordinates (FIG. 1) can be described by

$$\begin{matrix}{s}_{c} [ \begin{matrix}{u}_{c} \\ {v}_{c} \\ 1\end{matrix} ] = {M}_{c} [ \begin{matrix}{X}_{W} \\ {Y}_{W} \\ {Z}_{W} \\ 1\end{matrix} ] , & ( 3 ) \\ {s}_{p} [ \begin{matrix}{u}_{p} \\ {v}_{p} \\ 1\end{matrix} ] = {M}_{p} [ \begin{matrix}{X}_{W} \\ {Y}_{W} \\ {Z}_{W} \\ 1\end{matrix} ] , & ( 4 )\end{matrix}$$

where s_{c}, and sₚ are scale factors, and M_{c} implicitly represents the intrinsic and extrinsic parameters for the camera and Mₚ for the projector. Camera images and the virtual projector images of the checkerboard at several orientations are used to perform camera and projector calibrations, where M_{c} and Mₚ are solved for in a least-squares sense, using known camera image coordinates (u_{c}, v_{c}) and the corresponding world coordinates (X_{W},Y_{W},Z_{W}), and using the corresponding known projector image coordinates (uₚ, vₚ) and the same corresponding world coordinates, respectively. During a surface-shape measurement, 3D reconstruction of a surface point P (FIG. 1) can be performed from its corresponding camera and projector coordinates (u_{c}, v_{c}) and (uₚ, vₚ), and M_{c}, and Mₚ, respectively, determined during the camera-projector system calibration.

Recalibration for Camera-Projector Stereovision

The recalibration procedure involves using a single pose (position and orientation) of the calibration board. The user would position the board once in a single position (the preferred pose is with the optical axis of the camera approximately perpendicular to the plane of the board, the projector would project horizontal and vertical fringe patterns onto the board, camera images would be captured for each projected pattern, phase values for the horizontal and vertical fringe patterns would be calculated, correspondences between camera and projector images would be determined as above, and the calibration parameters would be recomputed as follows. The rigid transformation T that relates the camera pose to the projector pose includes the rotation matrix and translation vector as follows:

T(P_{C})=RP_{C}+τ (5)

where R is a rotation matrix and τ is a translation vector. The rotation matrix R is given by:

$$R = [ \begin{matrix}c γ c β & c γ s β s α - s γ c α & c γ s β c α + s γ s α \\ s γ c β & s γ s β s α + c γ c α & s γ s β c α - c γ s α \\ - s β & c β s α & c β c α\end{matrix} ] \qquad ( 6 )$$

where c and s, are abbreviations for cosine and sine, respectively; and α, β, γ, are the rotation angles about the x, y and z axes respectively. The translation vector is given by:

τ=[tₓt_{y}t_{z}]^{T} (7)

in x, y, and z directions, respectively.

Various optimization methods can be used to modify the rotation angles α, β, γ, and translation components tₓ, t_{y}, and t_{z} to minimize the reprojection error, defined as the sum of the squared 2D image distances between 3D control points projected back to the image plane and the corresponding detected 2D control points. The recalibration is not restricted to any one optimization method. For all optimization methods, the six transformation parameters α, β, γ, tₓ, t_{y}, t_{z} would be initialized to the parameters determined during the most recent calibration of the MCD-projector system, or another set of parameters considered as the reference starting calibration parameters, such as those determined during factory calibration.

One effective optimization technique is to vary α, β, γ, tₓ, t_{y}, t_{z}, one at a time in cyclic sequence, evaluating the reprojection error at every iteration, continuing with modification of the same parameter until the error becomes worse (greater), reversing the last iteration that caused the greater error, modifying the parameter in the opposite direction (opposite sign) until the error increases, and changing to modify the next parameter in the sequence once a forward and reverse step have been made on the current parameter. Once a complete cycle of modifying all parameters in the sequence has been made, the step size of the parameter modification can be reduced, for example by half, to effectively perform a finer (higher resolution) modification for each complete cycle. The optimal parameters would be determined once a stopping criterion has been met, such as the number of iterations has reached a predetermined threshold maximum, a desired level of reprojection accuracy has been attained, or there is no change in the reprojection error with parameter modification.

Phase-to-Height Mapping and Intensity-Ratio-to-Height (Applicable to the Triangular Two-Step Method)

Calibration by conversion of phase to surface height or depth (or in the case of two-step triangular intensity profile patterns, conversion of intensity ratio to height) involves sequentially projecting multiple phase-shifted patterns onto a flat white board positioned at multiple known positions along a single axis perpendicular to the plane, and computing the phase or intensity ratio at every camera pixel for every known board position. A mapping of phase to height (or intensity-ratio-to-height) may be computed in a least squares sense, thereby determining a single multiplication constant at every pixel to convert phase (or intensity ratio) to height, or multiple constants to convert phase (or intensity ratio) to height.

Sinusoidal Pattern Phase-to-Height Mapping

The phase-to-height mapping function for calculating the surface height of the object relative to the reference plane can be written as:

h(x,y)=K(x,y)Δφ(x,y), (8)

where

$$K ( x , y ) = \frac{pH ( x , y )}{2 π d} .$$

K(x, y) is a coefficient of the optical setup and a function of (x, y), p is the period, and H is the distance of the camera and projector to the reference plane. The phase difference Δφ(x, y) can be calculated by:

Δφ(x,y)=φ(x,y)−φᵣ(x,y), (9)

where φ(x, y) is the distorted fringe phase distribution of the object surface, and φᵣ(x, y) is the reference fringe phase distribution taken from a reference plane. Both φ(x, y) and φᵣ(x, y) can be obtained for any image point. The coefficient K(x, y) can be determined from a system calibration. For surface-geometry measurement of an unknown object, once Δφ(x, y) is obtained by applying Eq. 9, h, the height of the object, can be determined for any image point (x, y) using Eq. 8. If K(x, y) and h(x, y) are known for any point (x, y), rearrangement of Eq. 8 allows the phase difference to be calculated at that point as follows:

$$Δϕ ( x , y ) = \frac{h ( x , y )}{K ( x , y )} . \qquad ( 10 )$$

The non-linear relationship between the phase difference map and the surface height of the object can be arranged as:

$$Δϕ = \frac{\frac{2 π d}{pH} h}{1 - \frac{1}{H} h} . \qquad ( 11 )$$

Considering the x-y dimensions, Eq. 11 can be expressed simply as:

$$Δϕ ( x , y ) = \frac{m ( x , y ) h ( x , y )}{1 - n ( x , y ) h ( x , y )} , \qquad ( 12 )$$

where

$$m ( x , y ) = \frac{2 π d}{pH ( x , y )} , n ( x , y ) = \frac{1}{H ( x , y )} ,$$

m and n are system parameters relating to the optical setup, and x, y are the pixel coordinates. Eq. 12 can be rewritten as the following phase-to-height mapping function:

$$h ( x , y ) = \frac{Δϕ ( x , y )}{m ( x , y ) + n ( x , y ) Δϕ ( x , y )} . \qquad ( 13 )$$

As it is difficult to precisely determine the parameter p, the fringe pitch in the reference plane, which is actually not constant across the image due to the divergence of rays from the projector, a calibration is performed to determine the unknown coefficients that relate the height of the object to the phase-difference, without having to explicitly know the system parameters related to the system configuration. This involves determining K(x, y) in Eq. 8 for the linear calibration, and m(x, y) and n(x, y) in Eq. 13 for the non-linear calibration.

Linear Calibration

To determine the coefficient K(x, y) in Eq. 8, a calibration reference plane, which may be in the form of a white board, must be translated through a known distance along the Z direction relative to the reference plane. Here the reference plane is translated to different known calibration positions of depth hᵢ, where i=1, 2, . . . N is the calibration position and N is the number of positions. By applying Eq. 8, the phase-height relationship for each pixel (x, y) can be determined at each calibration position as follows:

hᵢ(x,y)=K(x,y)Δφᵢ(x,y)

i=1,2, . . . N, (14)

where the phase difference Δφᵢ(x, y) is obtained by:

Δφᵢ(x,y)=φᵢ(x,y)−φᵣ(x,y)

i=1,2, . . . N, (15)

where φᵢ(x, y) is the calibration phase distribution due to the translation hᵢ of the calibration plane relative to the reference plane, φᵣ(x, y) is the phase distribution of the reference plane, and both φᵢ(x,y) and φᵣ(x,y) can be obtained from the captured intensity images acquired at each calibration position and the reference plane, respectively, by applying a phase-shifting technique. The system is calibrated by moving the calibration plate to several different positions. Applying a least-squares algorithm to linear Eq. 14, the following equation is used to obtain the coefficient K(x, y) and thus complete the system calibration:

$$K ( x , y ) = \frac{{\sum }_{i = 1}^{N} {Δϕ}_{i} ( x , y ) {h}_{i} ( x , y )}{{\sum }_{i = 1}^{N} {Δϕ}_{i}^{2} ( x , y )} . \\ i = 1 , 2 , … N \qquad ( 16 )$$

where i=1, 2, . . . N is the calibration position and N is the number of positions.

With K(x,y) determined, the height or depth of any object surface can be determined from Eq. 8 by first acquiring the phase-difference distribution using Eq. 9.

Non-Linear Calibration

The non-linear calibration is similar to the linear calibration except that two parameters m(x, y) and n(x, y) of Eq. (13) are determined instead of the single coefficient K(x, y). The phase difference can be obtained using the same method as in the linear calibration. To calibrate over the entire object-space working, a least-squares method is applied to determine parameters m(x, y) and n(x, y) in Eq. 13, which can be rearranged as:

Δφ(x,y)=m(x,y)h(x,y)+n(x,y)h(x,y)Δφ(x,y). (17)

By choosing h(x, y) and h(x, y)φ(x, y) as the basis functions, and applying the least-squares algorithm, the sum of squares is:

$$q = {\sum }_{i = 1}^{N} {[ {Δϕ}_{i} ( x , y ) - m ( x , y ) {h}_{i} ( x , y ) - n ( x , y ) {h}_{i} ( x , y ) {Δϕ}_{i} ( x , y ) ]}^{2} , \qquad ( 18 )$$

where q depends on m(x, y) and n(x, y). A necessary condition for q to be minimum is:

$$\frac{\partial q}{\partial m ( x , y )} = - 2 {\sum }_{i = 1}^{N} [ {Δϕ}_{i} ( x , y ) - m ( x , y ) {h}_{i} ( x , y ) - n ( x , y ) {h}_{i} ( x , y ) {Δϕ}_{i} ( x , y ) ] {h}_{i} ( x , y ) = 0 , \\ \frac{\partial q}{\partial n ( x , y )} = - 2 {\sum }_{i = 1}^{N} [ {Δϕ}_{i} ( x , y ) - m ( x , y ) {h}_{i} ( x , y ) - n ( x , y ) {h}_{i} ( x , y ) {Δϕ}_{i} ( x , y ) ] {h}_{i} ( x , y ) {Δϕ}_{i} ( x , y ) = 0 ,$$

which can be arranged as:

$$\begin{matrix}m ( x , y ) {\sum }_{i = 1}^{N} {h}_{i}^{2} ( x , y ) + ( x , y ) {\sum }_{i = 1}^{N} {h}_{i}^{2} ( x , y ) {Δϕ}_{i} ( x , y ) = {\sum }_{i = 1}^{N} {h}_{i} ( x , y ) {Δϕ}_{i} ( x , y ) \\ m ( x , y ) {\sum }_{i = 1}^{N} {h}_{i}^{2} ( x , y ) {Δϕ}_{i} ( x , y ) + n ( x , y ) {\sum }_{i = 1}^{N} {h}_{i}^{2} ( x , y ) {Δϕ}_{i}^{2} ( x , y ) = {\sum }_{i = 1}^{N} {h}_{i} ( x , y ) {Δϕ}_{i}^{2} ( x , y )\end{matrix} \} \qquad ( 19 )$$

Equation 19 can be written in matrix form as:

$$( \begin{matrix}{a}_{1} ( x , y ) & {a}_{2} ( x , y ) \\ {a}_{2} ( x , y ) & {a}_{3} ( x , y )\end{matrix} ) ( \begin{matrix}m ( x , y ) \\ n ( x , y )\end{matrix} ) = ( \begin{matrix}{b}_{1} ( x , y ) \\ {b}_{2} ( x , y )\end{matrix} ) , \\ where \\ {a}_{1} ( x , y ) = {\sum }_{i = 1}^{N} {h}_{i}^{2} ( x , y ) , \\ {a}_{2} ( x , y ) = {\sum }_{i = 1}^{N} {h}_{i}^{2} ( x , y ) {Δϕ}_{i} ( x , y ) , \\ {a}_{3} ( x , y ) = {\sum }_{i = 1}^{N} {h}_{i}^{2} ( x , y ) {Δϕ}_{i}^{2} ( x , y ) , \\ {b}_{1} ( x , y ) = {\sum }_{i = 1}^{N} {h}_{i} ( x , y ) {Δϕ}_{i} ( x , y ) , \\ {b}_{2} ( x , y ) = {\sum }_{i = 1}^{N} {h}_{i} ( x , y ) {Δϕ}_{i}^{2} ( x , y ) . \qquad ( 20 )$$

The parameters m(x, y) and n(x, y) in Eq. 20 can be solved as:

$$\begin{matrix}m ( x , y ) = \frac{{a}_{3} ( x , y ) {b}_{1} ( x , y ) - {a}_{2} ( x , y ) {b}_{2} ( x , y )}{{a}_{1} ( x , y ) {a}_{3} ( x , y ) - {a}_{2}^{2} ( x , y )} \\ n ( x , y ) = \frac{{a}_{1} ( x , y ) {b}_{2} ( x , y ) - {a}_{2} ( x , y ) {b}_{1} ( x , y )}{{a}_{1} ( x , y ) {a}_{3} ( x , y ) - {a}_{2}^{2} ( x , y )}\end{matrix} \} . \qquad ( 21 )$$

After completing the calibration and getting the phase difference distribution, the 3-D coordinates of an object surface can be calculated from Eq. 13.

Two Step Triangular Pattern Intensity-Ratio-to-Height Mapping

The intensity equations for the two-step phase-shifted triangular fringe patterns are:

$$\begin{matrix}{I}_{1} ( x , y ) = \{ \begin{matrix}\frac{2 {I}_{m} ( x , y )}{T} x + {I}_{min} ( x , y ) + \frac{{I}_{m} ( x , y )}{2} & x ∈ [ 0 , \frac{T}{4} ) \\ - \frac{2 {I}_{m} ( x , y )}{T} x + {I}_{min} ( x , y ) + \frac{3 {I}_{m} ( x , y )}{2} & x ∈ [ \frac{T}{4} , \frac{3 T}{4} ) \\ \frac{2 {I}_{m} ( x , y )}{T} x + {I}_{min} ( x , y ) - \frac{3 {I}_{m} ( x , y )}{2} & x ∈ [ \frac{3 T}{4} , T )\end{matrix} , & ( 22 ) \\ {I}_{2} ( x , y ) = \{ \begin{matrix}- \frac{2 {I}_{m} ( x , y )}{T} x + {I}_{min} ( x , y ) + \frac{{I}_{m} ( x , y )}{2} & x ∈ [ 0 , \frac{T}{4} ) \\ \frac{2 {I}_{m} ( x , y )}{T} x + {I}_{min} ( x , y ) - \frac{{I}_{m} ( x , y )}{2} & x ∈ [ \frac{T}{4} , \frac{3 T}{4} ) \\ - \frac{2 {I}_{m} ( xx , y )}{T} x + {I}_{min} ( x , y ) + \frac{5 {I}_{m} ( x , y )}{2} & x ∈ [ \frac{3 T}{4} , T )\end{matrix} , & ( 23 ) \\ {I}_{m} ( x , y ) = {I}_{max} ( x , y ) - {I}_{min} ( x , y ) , & ( 24 )\end{matrix}$$

where Iᵢ(x,y) and I₂(x,y) are the intensities for the two shifted triangular patterns respectively, T is the pitch of the patterns, Iₘ(x,y) is the intensity modulation, and Iₘᵢₙ(x,y) and Iₘₐₓ(x,y) are the minimum and maximum intensities of the two triangular patterns, respectively. The intensity difference between the two patterns Iᵢ(x,y)−I₂(x,y) can be computed and then normalized by the intensity modulation Iₘ(x, y) as intensity-ratio r₀(x,y):

$${r}_{0} ( x , y ) = \frac{\vert {I}_{1} ( x , y ) - {I}_{2} ( x , y ) \vert}{{I}_{m} ( x , y )} . \qquad ( 25 )$$

The triangular shape of intensity-ratio r₀(x,y) can be converted to a ramp by applying the following equation:

$$r ( x , y ) = 2 \times round ( \frac{R - 1}{2} ) + {( - 1 )}^{R + 1} {r}_{0} ( x , y ) \\ R = 1 , 2 , 3 , 4 , \qquad ( 26 )$$

where R is the region number, which can be determined by comparing the intensity values of the two triangular patterns at each point and the relative position of this point over the range of the pitch. The intensity-ratio r(x, y), has a ramp shape with values ranging from 0 to 4.

Multiple triangular fringes can be used to increase measurement accuracy. In this case, the intensity-ratio r(x, y) is wrapped into the range of 0 to 4, as in the sinusoidal-pattern phase-shifting method, where the phase varies in the range of 0 to 2π. Both the wrapped intensity ratio of the triangular phase-shifting method, and the wrapped phase of the sinusoidal-pattern phase-shifting method, have a saw-tooth-like shape. Removal of the discontinuity of the wrapped intensity ratio requires a process similar to the phase unwrapping in the traditional sinusoidal-pattern phase-shifting method. The range information of the object is contained in this unwrapped intensity-ratio map.

Intensity-Ratio-to-Height Mapping

Similar to phase-to-height mapping in the sinusoidal-pattern phase-shifting method, intensity-ratio values for the 2-step triangular pattern are mapped to height over the entire object surface relative to the reference plane. Ar, the intensity-ratio difference between the object surface and the reference plane is determined by:

Δr=r−rᵣ, (27)

where r is the intensity-ratio of the object surface, and rᵣ is the intensity-ratio of the reference plane.

h(x,y)=K(x,y)Δr(x,y) (28)

The coefficient K(x, y) depends on the optical setup. The intensity-ratio difference Δr(x, y) can be calculated by:

Δr(x,y)=r(x,y)−rᵣ(x,y) (29)

where r(x, y) is the distorted fringe intensity-ratio distribution of the object surface, and rᵣ (x, y) is the reference fringe intensity-ratio distribution obtained from a planar reference plane. Both r(x, y) and rᵣ(x, y) can be obtained from the computation of Eq. 26 and an intensity-ratio unwrapping method if the triangular pattern is repeated. The intensity-ratio unwrapping method is a modification of the phase unwrapping method commonly used in the sinusoidal-pattern phase-shifting method.

The non-linear intensity-ratio to surface height mapping is developed from:

$$Δ r ( x , y ) = \frac{m ( x , y ) h ( x , y )}{1 - n ( x , y ) h ( x , y )} , \qquad ( 30 )$$

where m(x,y) and n(x,y) are system parameters relating to the optical setup, and x, y are the pixel coordinates. Eq. 30 can be rewritten as the following intensity-ratio-to-height mapping function:

$$h ( x , y ) = \frac{Δ r ( x , y )}{m ( x , y ) + n ( x , y ) Δ r ( x , y )} . \qquad ( 31 )$$

Calibration

The values of the parameters K(x,y) can be determined by a system calibration where Δr(x, y) is obtained at multiple known depths and K(x,y) is computed in a least-squares manner as with sinusoidal-pattern methods using the following equation:

$$K ( x , y ) = \frac{{\sum }_{i = 1}^{N} Δ {r}_{i} ( x , y ) {h}_{i} ( x , y )}{{\sum }_{i = 1}^{N} Δ {r}_{i}^{2} ( x , y )} \\ i = 1 , 2 , 3 , 4 … N , \qquad ( 32 )$$

where i is the position at known depth, and Nis the number of calibration positions.

A similar least-squares method is used to obtain m(x,y) and n(x,y), for the non-linear mapping of Eq. 31. Using h(x, y) and h(x, y)Δr(x, y) as the basis functions, the sum of squares can be written as:

$$q = {\sum }_{i = 1}^{N} {[ Δ {r}_{i} ( x , y ) - m ( x , y ) {h}_{i} ( x , y ) - n ( x , y ) {h}_{i} ( x , y ) Δ {r}_{i} ( x , y ) ]}^{2} , \qquad ( 33 )$$

where q depends on m(x, y) and n(x, y). A necessary condition for q to be minimum is:

$$\frac{\partial q}{\partial m ( x , y )} = 0 and \frac{\partial q}{\partial n ( x , y )} = 0.$$

By computation of these partial derivatives, m(x, y) and n(x, y) in Eq. 33 can be solved as:

$$\begin{matrix}m ( x , y ) = \frac{{a}_{3} ( x , y ) {b}_{1} ( x , y ) - {a}_{2} ( x , y ) {b}_{2} ( x , y )}{{a}_{1} ( x , y ) {a}_{3} ( x , y ) - {a}_{2}^{2} ( x , y )} \\ n ( x , y ) = \frac{{a}_{1} ( x , y ) {b}_{2} ( x , y ) - {a}_{2} ( x , y ) {b}_{1} ( x , y )}{{a}_{1} ( x , y ) {a}_{3} ( x , y ) - {a}_{2}^{2} ( x , y )}\end{matrix} \} . \\ where \text{:} \\ {a}_{1} ( x , y ) = {\sum }_{i = 1}^{N} {h}_{i}^{2} ( x , y ) , \\ {a}_{2} ( x , y ) = {\sum }_{i = 1}^{N} {h}_{i}^{2} ( x , y ) Δ {r}_{i} ( x , y ) , \\ {a}_{3} ( x , y ) = {\sum }_{i = 1}^{N} {h}_{i}^{2} ( x , y ) Δ {r}_{i}^{2} ( x , y ) , \\ {b}_{1} ( x , y ) = {\sum }_{i = 1}^{N} {h}_{i} ( x , y ) Δ {r}_{i} ( x , y ) , \\ {b}_{2} ( x , y ) = {\sum }_{i = 1}^{N} {h}_{i} ( x , y ) Δ {r}_{i}^{2} ( x , y ) . \qquad ( 34 )$$

Recalibration for Phase-to-Height and Intensity-Ratio-to-Height Mapping Methods

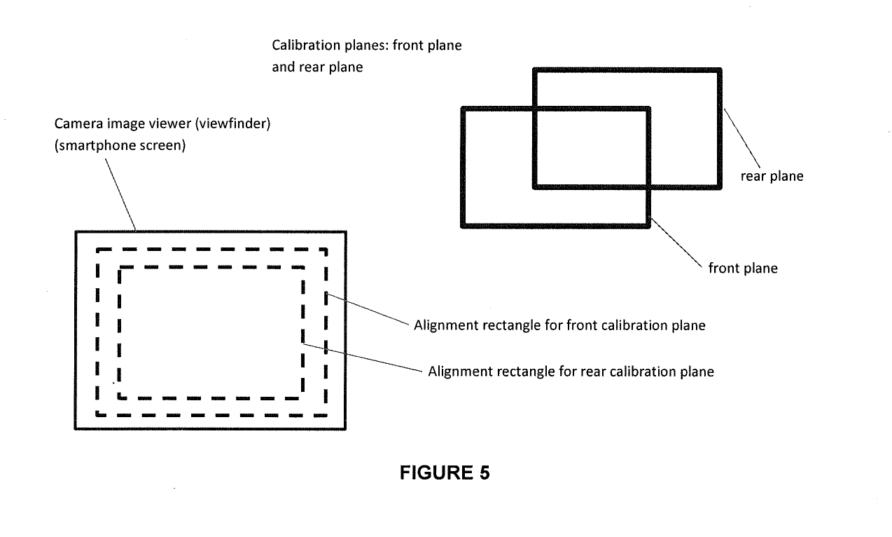

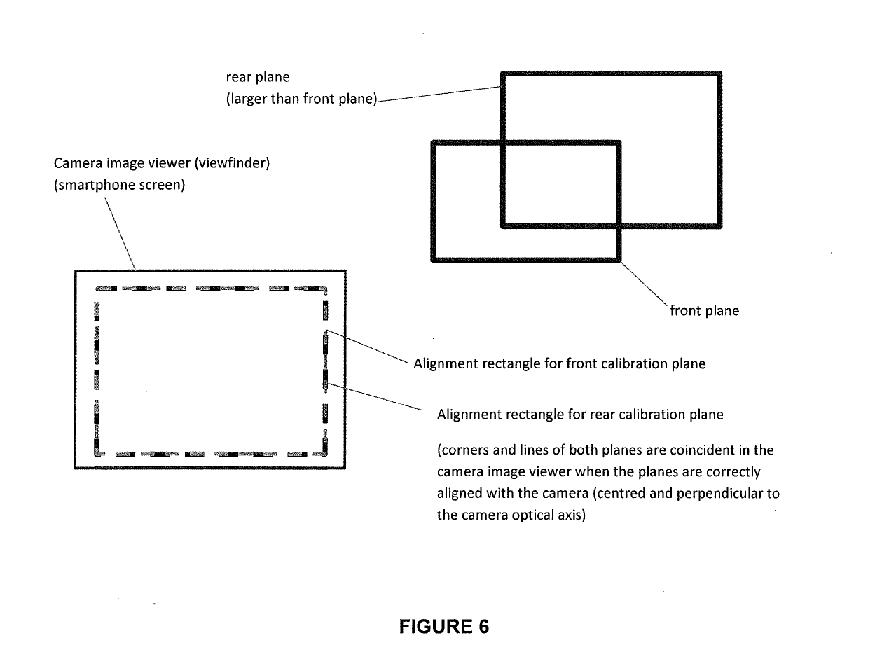

The recalibration procedure requires the user to position only once, a recalibration device including two white boards (front and rear) held in a frame with a known distance D apart. The recalibration device would be positioned such that in the camera image viewer of the MCD, the positions of the corners and edges of the front and rear boards would match the corners and edges of two alignment shapes displayed in the camera image viewer of the MCD. In the preferred embodiment, the shapes would be rectangles, or more specifically, edges of the rectangles, but other shapes that guide alignment of the boards could be used. The two alignment shapes may be separate in the camera image viewer (FIG. 5) if the front and rear boards are approximately the same size. In a preferred embodiment, the two alignment shapes (rectangles) would be coincident (FIG. 6) and the rear board would be larger than the front board such that in the camera image viewer, the corners and edges of both boards align with the coincident alignment shapes (rectangles). Fringe patterns would then be projected onto the front board and camera images captured. The user would then remove the front board from the frame. Fringe patterns would then be projected onto the rear board and camera images captured. The calibration parameters K(x,y) for every camera pixel (x,y) would be individually modified (either increased or decreased) iteratively to optimize each parameter so that the calculated depth d between the two board positions best matches the known depth, D. For every pixel, the K(x,y) corresponding to the best match or lowest error e=(d-D) would be the final adjusted calibration parameter. This would be done for every camera pixel. Alternatively, the adjustment of K(x,y) would be done for a subset of pixels and interpolation of K(x,y) values performed across the map (x,y). Alternative computation of lowest error would be based on a squared difference, a sum of differences or a sum of squared differences, or other known mathematical methods in optimization or error minimization. The preferred embodiment would adjust the K(x,y) values. Alternatively, using a non-linear recalibration, m(x,y) and n(x,y) would be adjusted for each pixel until the calculated depth d between the two board positions best matches the known depth, D, for each pixel.

An alternative recalibration would adjust the K(x,y) values at each pixel based on a single known position (and orientation) of the board at a single position. The known position of the board may be achieved using a calibration device bracket to temporarily fix the recalibration board to the apparatus 10, using an alignment shape in the camera image viewer, or by other optical or physical means.

Current Technology in Comparison to Previous Technology

The objective of the current technology is to provide 3D image acquisition (3D surface measurement) capability in the hands of the common consumer. More specifically, the disclosure provides a technology that enables a MCD (smartphone or i-Pod Touch™) to acquire 3D images.

Previous 3D acquisition methods that used digital-fringe-pattern projection also used a computer for controlling fringe pattern projection, 2D image acquisition, image processing and computation of 3D coordinates. The system and method of the disclosure represents a novel 3D digital-fringe-pattern projection based 3D imaging system where all processes are controlled and carried out on the MCD with digital fringe patterns projected by a projector which is controlled by the MCD.

The current technology described herein combines fringe projection with the camera of a MCD which differs from other previous attempts at providing 3D imaging by a mobile communication device. In arriving at the system and method of the current disclosure, numerous different techniques were attempted in trying to develop the right combination of techniques that would enable successful highly-accurate high resolution 3D image acquisition using a MCD.

In an alternative embodiment, the system and method of the disclosure also provides a 3D digital-fringe-pattern projection based 3D imaging system where all processes are controlled by a MCD with digital fringe patterns projected by a projector which is controlled by the MCD, and the computation of 3D coordinates is carried out by a computer, which may be remotely located, such as via cloud computing or may take advantage of 3G or WiFi communication or other wired or wireless communication. The apparatus and method may also include the MCD receiving from the computer, the 3D coordinates of the computed 3D image or 3D surface measured.

Further embodiments may include some processes to be controlled and performed on the MCD, projector, and a computer, in any combination and completion of processes in part or in whole on any of these devices (component).

In one embodiment, the technology for 3D surface-shape measurement (3D imaging) involves different functionality such as 3D surface measurement and calibration of projector-MCD-camera system. More specifically, 3D surface measurement involves, but is not limited to, i) projecting fringe patterns onto the object using a miniature image (data) projector, ii) using the smartphone's camera to capture 2D images of the deformed light patterns that are formed on the object surface by the projected light patterns, and iii) determining the 3D coordinates that define the shape of the surface from these 2D images, using computer algorithms as well as parameters from a calibration of the camera-projector system. Calibration of projector-smartphone-camera system includes iv) calibrating the smartphone-camera-projector system to determine the parameters required for determination of the 3D coordinates of the object surface (termed 3D reconstruction of the object surface). The calibration can be performed prior to the 2D image capture for 3D surface-shape measurement or afterwards, but must be done before step (iii) above.

In the current embodiment, with the low quality cameras in MCDs, various techniques were tested to find the right combination of techniques that would enable successful highly-accurate high-resolution 3D image acquisition using a MCD.

In order to acquire 3D images, the smartphone-camera and projector have the exact same relative pose (position and orientation) (between the two devices) during the smartphone-camera-projector calibration and during the 3D surface measurement. In one type of embodiment the invention includes a quick recalibration of the camera-projector system to accommodate any changes in camera-projector geometry since the previous calibration. An apparatus for having the end-user temporarily fix the smartphone with camera in a new pose in relation to the projector, is provided by a docking device that is either adjustable or allows multiple docking poses, or a combination of multiple poses and adjustability, and the end-user would recalibrate the camera-projector before or after 2D image acquisition for the 3D image acquisition, in order to permit the 3D image acquisition.

In another embodiment, the camera-projector system is developed to not need recalibration whereby the smartphone and projector are rigidly fixed to each other, at least temporarily, until both the 3D surface measurement and calibration have been completed. This can be carried out by various physical means which are part of the technology. In one embodiment, the smartphone (with its embedded camera) and projector relative positioning would be repeatable by a precision docking device, so that the 2D image acquisition for the 3D image acquisition can be carried out by the user without camera-projector recalibration by the user. In another embodiment, the smartphone will have an embedded projector at an appropriate pose so that the docking device is not needed to obtain precision and permanent relative pose between the smartphone camera and projector, and the 2D image acquisition for the 3D image acquisition can be carried out by the user without camera-projector calibration or recalibration by the user.

In step (i), fringe patterns may be projected digitally by a data projector or alternatively by a light projector (laser, LED or other) that projects light through a grating or other optical device to produce a fringe pattern, or other means. For example, individual projection of fringes can be done, projection of a square wave rather than sinusoidal, projection of black and white stripes (binary image), projection of defocused stripes to form a continuous or nearly continuous pattern, individual projection of stripes, separate projection or portions of the full pattern by different light sources, such as an array of LEDs. Stripes may be approximately of uniform period, purposely not uniform, and either periodic or not periodic. Any varying projected light pattern that is full field across part of the object surface (appearing full field in the camera view) can be used. Shift of light patterns may be achieved mechanically by a miniature or micro positioning device or any device that is vibrating, translating, rotating, or moving in another way, a moving optical device (for example, a rotating mirror), the entire projection device may be moving or parts of it moving, or shifting can be done purely digitally by projecting any number of alternative patterns. Shift of light patterns may be achieved electronically, by switching the light source that projects the fringe pattern, or partial fringe pattern. This includes switching the light source that projects light through a grating, to produce a shifted pattern, or other means to project a fringe pattern from different light sources so that effectively the projected pattern is shifted. Colour, gray, or binary (black and white) encoded fringe patterns that are not shifted are alternative patterns that may be used.

In steps (i, ii, iii, and iv), different known fringe-projection techniques can be used: three- or four-step phase shifting using three or four phase-shifted fringe patterns, respectively, having sinusoidal intensity profiles where the phase is computed at each pixel and the height or depth of the surface at each camera pixel is computed from the phase at each pixel; phase shifting using two phase-shifted fringe patterns having triangular intensity profiles where intensity ratio is computed at each pixel and the height or depth of the surface at each camera pixel is computed from the intensity ratio at each pixel, and other variations of fringe projection using multiple fringe patterns (more than 3 or 4). In the two and three and more pattern techniques, the phase-shifted patterns are projected sequentially and images of the distorted pattern on the object surface are captured and used in the 3D reconstruction. “One-shot” techniques, where the two or three phase shifted patterns are imbedded together in a single composite pattern, and a single image is captured may be used. For example using three different colours, recorded on Red, Green, and Blue channels of a colour camera may also be used. More than three patterns imbedded into a single pattern may also be used. Single pattern, single image techniques may be used where phase-shifted patterns are created in a postprocess. For example, after a single fringe pattern is projected onto a surface and a 2D image of the deformed pattern is captured, an undeformed fringe or grid pattern can be overlaid onto the captured 2D image and shifted, to produce Moiré contours from which phase and surface height can be computed. Other single pattern techniques may be used, such as spatial carrier and Fourier techniques. Patterns do not have to be intensity profiles that are triangular, sinusoidal or periodic. Binary stripes may be used, (black and white other grey levels, or two colours), and defocused binary or other defocused patterns may be used. Aperiodic patterns may be used. Patterns projected may be uniform or non-uniform in period, or approximately uniform or of varying period. Colour, gray or binary (black and white) encoded fringe patterns without shifting may be used.

In steps (i) and (ii) projector and camera gamma correction methods can be used, respectively.

Phase unwrapping is a step often included in the phase calculation process, that calculates unwrapped phase from wrapped phase, whose values are restricted to a range [−Π, Π] or [0 to 2Π]. Various spatial and temporal phase unwrapping methods may be used. Alternatively, fringe codification of various forms such as code words may be used. Phase unwrapping may be unnecessary.

Camera-projector calibration techniques for step (iv) have been described earlier.

While various techniques have been described above, this is only a brief summary and not exhaustive description of all possible techniques that can be used with the technology. The technology is not restricted to a single specific type of fringe projection technique among various known techniques, nor to a specific phase shifting technique among various known techniques, nor to a specific phase unwrapping method, nor to a specific calibration method, nor to a specific phase or intensity-ratio to surface height (depth) conversion method. However, some combinations of techniques have been unsuccessful or have led to low accuracy. The preferred embodiment or preferred combination of techniques demonstrated to yield high accuracy with high spatial resolution is the following:

In one embodiment of a method of the disclosure, four sinusoidal phase-shifted patterns are used with the system calibration using a calibration board including white circles in a grid on a black background where the centroids of the circles are the calibration points. Next, using the centroids of the circles and an offset correction for the circles appearing oval in the images, projector and camera gamma correction may be performed. In stereovision calibration, where the projector is treated as an inverse camera, projection of horizontal phase shifted patterns and vertical phase shifted patterns is done to determine horizontal-vertical phase combination to determine correspondence between camera and projector images. A modified heterodyne temporal phase unwrapping method may then be done where outlier phase values are corrected rather than discarded to keep all calibration points and not reduce the size of the calibrated region. After this has been completed, 3D reconstruction of the surface geometry of the object using projection of horizontal phase shifted patterns and vertical phase shifted patterns and the phase values of both sets for conversion to height (depth) using the calibration parameters determined during the projector-camera calibration is then performed.

Additional methods of the technology permit the user to project all phase-shifted patterns by the projector, acquire all 2D images for the 3D surface measurement, reconstruct the 3D surface shape, and display a new surface by projecting a surface representation of the measured surface (cloud of points, fitted surface to the acquired 3D coordinates, or other format), all by running a single MCD application (app) on the MCD. The MCD thus controls the running of each step of the 3D image acquisition processes in the proper sequence (for example projecting patterns by the projector and capturing images by the camera). Alternatively, all of these steps may be individually carried out by running a separate app on the MCD for each step, or various combinations of steps can be run from a single app. Similarly, the projection of patterns by the projector, acquisition of 2D images for the camera-projector calibration, and computation of the calibration parameters, may be carried out by running a single app, or multiple apps for multiple steps in various combinations. Similarly, the projection of patterns by the projector, acquisition of 2D images for the camera-projector recalibration, and computation of the calibration parameters, may be carried out by running a single app, or multiple apps for multiple steps in various combinations.

In one embodiment, the recalibration apparatus may be either i) a black board with a plurality of white circles arranged in a grid (for example 10×10, 10×20; or ii) three black boards each having white circles arranged in a grid, such that the three boards are mutually angled with respect to each other; or iii) three black boards each having white circles arranged in a grid, such that the three boards are parallel and fixed to the docking device or not fixed to the docking device, and each board can be removed one at a time without disturbing the position and orientation of the other boards; or iv) a frame that holds two white boards, a front board and a rear board, parallel to each other at a known distance apart, where the front board can be removed without moving the rear board. The boards can be of any shape, although rectangular would be most convenient for handling and alignment.

The recalibration apparatus may serve as a calibration apparatus.

For calibration and recalibration of the camera-projector, the calibration (or recalibration) device, in any form, may be attached rigidly to the camera-projector by a calibration (or recalibration) device docking station, which is either attached to the camera, projector, or both. Alternatively, the calibration (or recalibration) device may be unattached to the camera-projector for calibration (or recalibration) purposes.

The above-described embodiments are intended to be examples only. Alterations, modifications and variations can be effected to the particular embodiments by those of skill in the art without departing from the scope, which is defined solely by the claims appended hereto.

What is claimed is:

1. A method of three-dimensional (3D) imaging for use by a handheld portable device, comprising:
projecting at least one fringe pattern onto a surface;
capturing a two-dimensional (2D) camera image of each deformed light pattern formed by the projected at least one fringe pattern; and
determining shape of the surface.

2. The method of claim 1 wherein the handheld portable device is a mobile communication device.

3. The method of claim 1 further comprising:
calibrating or recalibrating the 3D imaging apparatus.

4. The method of claim 3 wherein recalibrating the 3D image comprises:
modifying previously calculated calibration parameters.

5. The method of claim 4 wherein modifying previously calculated calibration parameters comprises:
performing calculations based on a difference between a calculated position of a recalibration object surface and a known position of the recalibration object surface using at least one point on a surface of the recalibration object.

6. The method of claim 4 wherein the difference is one of a square difference, a sum of differences or a sum of squared differences.

7. The method of claim 4 wherein modifying previously calculated calibration parameters comprises:
performing calculations based on a difference between a calculated distance and a known distance between a first position of a recalibration object and at least one other position of the recalibration object using at least one point on a surface of the recalibration object.

8. Apparatus for three-dimensional (3D) imaging using a handheld portable device comprising:
a light pattern generator for projecting at least one fringe pattern onto a surface;
a two-dimensional (2D) image capture device for capturing at least one 2D image of the at least one light pattern formed by the projected at least one fringe pattern;
a processor for determining shape of the surface based on the at least one 2D image.

9. The apparatus of claim 8 further comprising:
a mounting apparatus for maintaining a predetermined distance or orientation or both distance and orientation, between the 2D image capture device and the projector.

10. The apparatus of claim 8 further comprising:
a recalibration object.

11. The apparatus of claim 10 wherein the recalibration object is at least one flat board.

12. The apparatus of claim 10 wherein the recalibration object is at least two flat boards kept spaced apart in an approximately parallel relationship.

13. The apparatus of claim 10 further comprising:
an alignment mechanism for aligning the 2D image capture device in relation to the recalibration object.

14. The apparatus of claim 13 wherein the alignment mechanism comprises:
a displayed shape; and
a view of at least one part of the recalibration object.

15. The apparatus of claim 13 wherein the alignment mechanism comprises:
a physical attachment between the two-dimensional (2D) image capture device and recalibration object.

16. The apparatus of claim 14 wherein the displayed shape is within an image capture device viewfinder or image capture device display screen.
